(19) United States
(12) Patent Application Publication
(10) Pub. No.: US 2015/0344033 A1
(43) Pub. Date: Dec. 3, 2015

(54) APPARATUS AND COMPUTER PROGRAM FOR ASSISTING DRIVER OF VEHICLE

(71) Applicant: DENSO CORPORATION, Kariya-city (JP)

(72) Inventors: SHOTARO FUKUDA, Obu-shi (JP); HIROAKI NIINO, Toyota-shi (JP); MASAO OOOKA, Gamagori-shi (JP); TAKAHIRO NARITA, Nagoya (JP)

(21) Appl. No.: 14/724,878

(22) Filed: May 29, 2015

(30) Foreign Application Priority Data
May 30, 2014 (JP) 2014-112903

(51) Int. Cl. B60W 30/16

(52) U.S. Cl. CPC B60W 30/16; B60W 2550/306

(57) ABSTRACT

In a driver assisting apparatus, a predicting unit predicts, based on information including at least a current location and a behavior of each of a preceding vehicle and a target vehicle, an overtaking course from the current location of the target vehicle to a future location of the target vehicle when assuming that the target vehicle will safely overtake the preceding vehicle. The target and preceding vehicles are running on a road. A determining unit determines whether there are one or more physical impediments for an overtaking of the preceding vehicle through the predicted overtaking course based on at least traffic information associated with at least a portion in the road in front of the current location of the target vehicle. An adjusting unit adjusts assistance for the driver of the target vehicle for the overtaking of the at least one preceding vehicle according to a result of the determination.

### CROSS REFERENCE TO RELATED APPLICATION

This application is based on and claims the benefit of priority from Japanese Patent Application No. 2014-112903 filed on May 30, 2014, which is incorporated in its entirety herein by reference.

### TECHNICAL FIELD

The present disclosure relates to apparatuses and computer programs for assisting drivers of vehicles.

### BACKGROUND

An example of these apparatuses is disclosed in Japanese Patent Application Publication No. 2011-137370, which will be referred to as patent document 1.

The apparatus disclosed in the patent document 1 is designed to determine whether there is a higher probability of a vehicle, assisted by the apparatus, departing from a recommended travelling course for the corresponding vehicle when the assisted vehicle tries to make a lane change. The apparatus is designed to guide the driver not to make a lane change when it is determined that there is a higher probability of the assisted vehicle departing from the recommended travelling course.

### SUMMARY

Drivers of vehicles have requirements to suitably pass a preceding vehicle running ahead of their vehicles. Unfortunately, the apparatus disclosed in the patent document 1 cannot suitably assist the driver's driving of a vehicle, assisted by the apparatus, when the driver is trying to pass a preceding vehicle running ahead of the assisted vehicle.

In view of the circumstances set forth above, one aspect of the present disclosure seeks to provide apparatuses and computer programs for assisting drivers of vehicles, which are capable of addressing the requirements set forth above.

Specifically, an alternative aspect of the present disclosure aims to provide such apparatuses and computer programs, each of which is capable of suitably assisting the driver of a target vehicle according to whether a driver enables the target vehicle to safely pass a preceding vehicle running ahead of the target vehicle without any obstacle.

According to a first exemplary aspect of the present disclosure, there is provided an apparatus for assisting a driver of a target vehicle running on a road. The apparatus includes a first obtaining unit that obtains first information including at least a current location and a behavior of at least one preceding vehicle running on the road ahead of the target vehicle, and a second obtaining unit that obtains second information indicative of a current location and a behavior of the target vehicle. The apparatus includes a predicting unit that predicts, based on the first information and the second information, an overtaking course from the current location of the target vehicle to a future location of the target vehicle assuming that the target vehicle will safely overtake the at least one preceding vehicle. The apparatus includes a determining unit that obtains traffic information associated with at least a portion in the road. The portion is located in front of the current location of the target vehicle. The determining unit determines whether there are one or more physical impediments for an overtaking of the at least one preceding vehicle through the predicted overtaking course based on at least the traffic information. The apparatus includes an adjusting unit that adjusts assistance for the driver of the target vehicle for the overtaking of the at least one preceding vehicle according to a result of the determination of whether there is at least one physical impediment to overtaking the at least one preceding vehicle through the predicted overtaking course.

According to a second aspect of the present disclosure, there is provided a computer program product for an apparatus for assisting a driver of a target vehicle running on a road. The computer program product includes a computer-readable storage medium, and a set of computer program instructions embedded in the computer-readable storage medium. The instructions cause a computer to carry out

(1) A first step of obtaining first information including at least a current location and a behavior of at least one preceding vehicle running on the road ahead of the target vehicle

(2) A second step of obtaining second information indicative of a current location and a behavior of the target vehicle

(3) A third step of predicting, based on the first information and the second information, an overtaking course from the current location of the target vehicle to a future location of the target vehicle assuming that the target vehicle will safely overtake the at least one preceding vehicle

(4) A fourth step of obtaining traffic information associated with at least a portion in the road, the portion being located in front of the current location of the target vehicle

(5) A fifth step of determining whether there are one or more physical impediments to overtaking the at least one preceding vehicle through the predicted overtaking course based on at least the traffic information

(6) A sixth step of adjusting assistance for the driver of the target vehicle for the overtaking of the at least one preceding vehicle according to a result of the determination of whether one or more such impediments exist.

According to the result of the determination of whether there are one or more physical impediments for the overtaking of the at least one preceding vehicle through the predicted overtaking course, the adjusting unit or the sixth step adjusts assistance for the driver of the target vehicle for the overtaking of the at least one preceding vehicle.

This configuration of the apparatus or the computer program product therefore suitably assists the driver when the driver tries to overtake the at least one preceding vehicle according to whether there are one or more physical impediments for the overtaking, i.e. whether the driver enables the target vehicle to safely pass the at least one preceding vehicle.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall structure of a driver assist system installed in a vehicle according to an embodiment of the present disclosure;

FIG. 2 is a flowchart schematically illustrating a lane-change assistance routine carried out by a controller of the driver assist system illustrated in FIG. 1;

FIG. 3 is a plan view schematically illustrating an example of an overtaking requirement distance calculated by the controller;

FIG. 4 is a plan view schematically illustrating one example of a relationship between an overtaking requirement distance and a minimum distance between a current location of the vehicle and the location of a physical impediment for an overtaking of one or more preceding vehicles through a predicted overtaking course according to this embodiment; and

FIG. 5 is a plan view schematically illustrating another example of a relationship between an overtaking requirement distance and a minimum distance between a current location of the vehicle and the location of a physical impediment for the overtaking of one or more preceding vehicles through a predicted overtaking course according to this embodiment.

### DETAILED DESCRIPTION OF EMBODIMENT

A specific embodiment of the present disclosure will be described hereinafter with reference to the accompanying drawings.

A driver assist system 1, to which an apparatus according to this embodiment is applied, is installed in a vehicle V, i.e. an own vehicle, a self-vehicle, or a target vehicle. For example, a passenger vehicle is used as the vehicle V. The driver assist system 1 has functions of assisting a driver's driving of the vehicle V travelling a lane of a road.

In particular, the driver assist system 1 is operative to determine whether the vehicle V can reliably and safely pass one or more preceding vehicles travelling on the same lane ahead of the vehicle V.

Based on the determination results, the driver assist system 1 is operative to give, to the driver of the vehicle V, a first suggestion, i.e. a first navigation. The first suggestion recommends the driver driving the vehicle V to pass the one or more preceding vehicles when it is determined that the vehicle V can reliably and safely pass the one or more preceding vehicles.

In contrast, when it is determined that the vehicle V cannot reliably and safely pass the one or more preceding vehicles, the driver assist system 1 is operative not to give, to the driver of the vehicle V, any suggestions or to give, to the driver of the vehicle V, a second suggestion, i.e. a second navigation, that recommends the driver of the vehicle V stopping overtaking the one or more preceding vehicles.

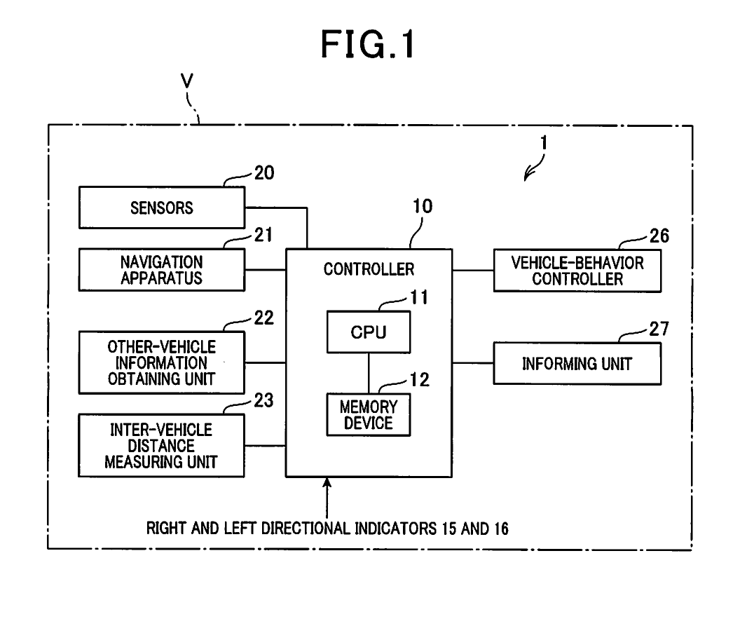

Referring to FIG. 1, the driver assist system 1 includes a controller 10, sensors 20, a navigation apparatus 21, an other-vehicle information obtaining unit 22, an inter-vehicle distance measuring unit 23, a vehicle-behavior controller 26, and an informing unit 27.

The sensors 20 are operative to measure various types of information representing the behavior of the vehicle V. For example, the sensors 20 include a yaw-rate sensor, a vehicle-speed sensor, and a steering-angle sensor. The yaw-rate sensor is operative to output, to the controller 10, a signal indicative of an angular velocity around a vertical axis of the vehicle V as a yaw rate of the vehicle V. The vehicle-speed sensor is operative to output, to the controller 10, the speed of the vehicle V. The steering-angle sensor is operative to output, to the controller 10, a signal indicative of a steering angle of the vehicle V.

The navigation apparatus 21 is communicably connected to the controller 10. The navigation apparatus 21 stores therein map information about where the vehicle V can travel. The navigation apparatus 21 is capable of detecting the current location of the vehicle V, and determining and displaying, on a map around the current location of the vehicle V displayed on a monitor thereof, one or more suitable routes to a specified destination from the current location of the vehicle V. This navigates the driver to drive the vehicle V in accordance with a selected one of the suitable routes to the specified destination.

The navigation apparatus 21 is also capable of cyclically accessing external infrastructural systems that can deliver traffic and travel information to road vehicle drivers. Each cyclic access obtains various pieces of traffic information at least a portion in the road; the portion is located in front of the current location of the target vehicle. The various pieces of traffic information include

(1) Information indicative of the number of lanes in each of roads located within a predetermined distance area around the current location of the vehicle V

(2) Information indicative of the locations of construction sites and accident sites within the predetermined distance area around the current location of the vehicle V

(3) Information indicative of the locations of non-passing zones, i.e. no-overtaking zones, within the predetermined distance area around the current location of the vehicle V

(4) Information indicative of the locations of traffic-jam areas within the predetermined distance area around the current location of the vehicle V.

The navigation apparatus 21 is further capable of sending the obtained traffic information to the controller 10 for each cyclic access.

The other-vehicle information obtaining unit 22 is capable of cyclically accessing other vehicles running within an accessible distance area around the current location of the vehicle V using known inter-vehicle communications and the other similar communication methods to obtain pieces of information from each of the other vehicles. The pieces of information from the other vehicles include the location and speed of each of the other vehicles, and the locations and speeds of each of further other vehicles located around each of the other vehicles. The other-vehicle information obtaining unit 22 is also capable of sending the pieces of information obtained from each of the other vehicles to the controller 10.

The inter-vehicle distance measuring unit 23 is capable of detecting a preceding vehicle running on the same lane immediately ahead of the vehicle V, and measuring an inter-vehicle distance and relative speed between the vehicle V and the preceding vehicle.

For example, the inter-vehicle distance measuring unit 23 includes a camera system provided with a stereo camera attached to, for example, the front center of the vehicle V. The stereo camera picks up three-dimensional images around the vehicle V, and the camera system manipulates the three-dimensional images to thereby obtain the inter-vehicle distance and relative speed between the vehicle V and a preceding vehicle running ahead of the vehicle V. The inter-vehicle distance measuring unit 23 can include a radar device operative to transmit probing waves, such as radar waves or laser waves to a predetermined scan region in front of the vehicle V, and receive echoes from at least one object based on the transmitted probing waves. Based on the received echoes, the radar device is operative to obtain the inter-vehicle distance and relative speed between the vehicle V and a preceding vehicle ahead of the vehicle V. The inter-vehicle distance measuring unit 23 is also capable of sending the inter-vehicle distance and the relative speed of a preceding vehicle ahead of the vehicle V to the controller 10.

The vehicle-behavior controller 26 includes various actuators that control the behavior of the vehicle V. For example, the actuators include an actuator that controls the position of a throttle valve for controlling the amount of air entering an internal combustion engine of the vehicle V. That is, the position of the throttle valve represents how the throttle valve is opened. Controlling the position of the throttle valve controls the speed of the vehicle V. The actuators also include an actuator that individually controls hydraulic pressure to be applied to a brake for each of the wheels of the vehicle V.

The vehicle-behavior controller 26 is communicably connected to the controller 10. The controller 10 instructs the vehicle-behavior controller 26 to adjust the position of the throttle valve and hydraulic pressure to be applied to the brake for each of the wheels. This adjustment controls the inter-vehicle distance and relative speed between the vehicle V and a preceding vehicle ahead of the vehicle V as instructed. The actuators can include an actuator that controls a steering angle of the vehicle V as instructed by the controller 10.

The informing unit 27 is communicably connected to the controller 10, and includes a speaker and a display. The informing unit 27 is capable of giving audible and visible information to the driver of the vehicle V using the speaker and display as instructed by the controller 10.

The controller 10 is mainly comprised of a well-known microcomputer consisting of, for example, a CPU 11 and a memory device 12, which is an example of non-transitory storage media. The memory device 12 includes at least one of a ROM and a RAM that is an example of non-volatile memories, which are communicably connected to each other. Such a non-volatile memory does not need power to retain data.

The CPU 11 performs various drive-assist routines, i.e. various sets of instructions, including an adaptive cruise control (ACC) routine that controls the actuators of the vehicle-behavior controller 26 to automatically adjust the speed of the vehicle V so that the vehicle V tracks a preceding vehicle ahead of the vehicle V. The drive-assist routines can include a routine that automatically controls the steering of the vehicle V. The drive-assist routines are stored beforehand in the ROM and/or RAM.

The vehicle V includes a right directional indicator 15 and a left directional indicator 16. A driver of the vehicle V instructs the right directional indicator 15 to output a turn signal before turning right. The driver also instructs the left directional indicator 16 to output a turn signal before turning left. The CPU 11 is communicably connected to the right and left directional indicators 15 and 16, and obtains the operating conditions of the right and left directional indicators 15 and 16.

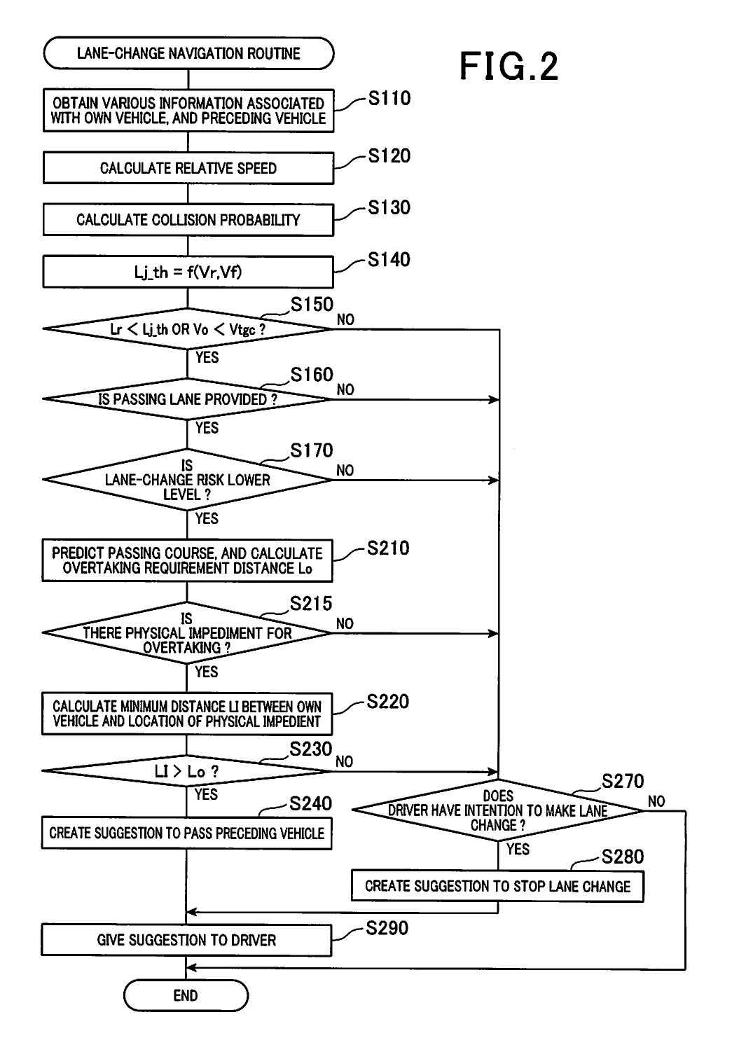

Next, operations of the driver assist system 1 according to this embodiment when the driver assist system 1 performs a lane-change assistance routine while executing the adaptive cruise control routine will be described hereinafter with reference to FIG. 2. The lane-change assistance routine is designed to determine whether the vehicle V can reliably and safely pass one or more preceding vehicles ahead of the vehicle V assuming that the vehicle V tries to pass one or more preceding vehicles during execution of the adaptive cruise control routine. According to the determination results, the lane-change assistance routine is designed to give one of the first and second suggestions or not to give any suggestions to the driver of the vehicle V during execution of the adaptive cruise control routine.

While executing the adaptive cruise control routine, the CPU 11 starts to perform the lane-change assistance routine when the inter-vehicle distance measuring unit 23 detects a preceding vehicle running ahead of the vehicle V. That is, the CPU 11 cyclically performs the lane-change assistance routine while a preceding vehicle running ahead of the vehicle is detected by the inter-vehicle distance measuring unit 23.

When starting the lane-change assistance routine, the CPU 11 obtains pieces of traffic information at least in front of the current location of the vehicle V from the navigation apparatus 21 in step S110. The pieces of traffic information at least in front of the current location of the vehicle V, include

(1) Information indicative of the number of lanes in front of the road on which the vehicle V is currently running within the predetermined distance area around the current location of the vehicle V

(2) Information indicative of the locations of construction sites and accident sites within the predetermined distance area in front of the current location of the vehicle V

(3) Information indicative of the locations of non-passing zones within the predetermined distance area in front of the current location of the vehicle V

(4) Information indicative of the locations of traffic-jam areas within the predetermined distance area in front of the current location of the vehicle V.

The CPU 11 also obtains the current location of the vehicle V from the navigation apparatus 21, and the speed, referred to Vo, of the vehicle V from the sensors 20 in step S110. Furthermore, the CPU 11 obtains the current location and speed, referred to Vf, of one or more preceding vehicles running on the same lane ahead of the vehicle V within the accessible distance area around the current location of the vehicle V from the other-vehicle information obtaining unit 22 in step S110.

In particular, if a plurality of preceding vehicles are running as a group ahead of the vehicle V within the accessible distance area around the current location of the vehicle V, the CPU 11 obtains the current location and speed Vf of one of the plurality of preceding vehicles, which is located immediately ahead of the vehicle V. This one of the plurality of preceding vehicles, which is located immediately ahead of the vehicle V, will be referred to as a target preceding vehicle. Otherwise, if a single preceding vehicle is running immediately ahead of the vehicle V, the CPU 11 obtains the current location and speed Vf of the single preceding vehicle as a target preceding vehicle.

Additionally, the CPU 11 obtains the operating conditions of the right and left directional indicators 15 and 16 in step S110. The CPU 11 can obtain information indicative of an operated condition of a passing switch that is operated by the driver when the driver tries to pass one or more preceding vehicles in step S110.

Next, in step S120, the CPU 11 calculates the relative speed, referred to Vr, of the target preceding vehicle with respect to the vehicle V based on the various pieces of information obtained in step S110. In step S120, the CPU 11 can calculate the relative speed of the target preceding vehicle according to the relative speed obtained by the inter-vehicle distance measuring unit 23.

Following the operation in step S120, the CPU 11 calculates a collision probability for the target preceding vehicle with respect to the vehicle V based on the various pieces of information obtained in step S110 in step S130. For example, the CPU 11 calculates a relative distance, referred to as Lr, between the current location of the target preceding vehicle and the vehicle V, and divides the calculated relative distance Lr by the relative speed Vr of the target preceding vehicle with respect to the vehicle V in step S130. This division calculates a predicted collision time between the target preceding vehicle and the vehicle V.

In addition, the CPU 11 divides the calculated relative distance Lr by the speed of the vehicle V in step S130. This division calculates a relative-time difference between the target preceding vehicle and the vehicle V. The CPU 11 uses the predicted collision time between the target preceding vehicle and the vehicle V, and the relative-time difference therebetween as parameters for calculating the collision probability for the target preceding vehicle with respect to the vehicle V in step S130.

Subsequently, the CPU 11 assigns the relative speed Vr and the speed Vf of the target preceding vehicle to a predetermined function included in the lane-change assistance routine or stored in the memory device 12 in step S140. The predetermined function, which is referred to as f(Vr, Vf) in FIG. 2, includes a correlation of values of an approach distance threshold with respect to values of the relative speed and the speed of a preceding vehicle. The approach distance threshold is used for determining the level of approach of the vehicle V with respect to the target preceding vehicle. Assigning the relative speed Vr and the speed Vf of the target preceding vehicle to the predetermined function calculates a value Lj_th of the approach distance threshold in step S140.

Then, the CPU 11 compares the relative distance Lr between the vehicle V and the target preceding vehicle with the value Lj_th of the approach distance threshold, and compares the speed Vo of the vehicle V with a target speed Vtgc predetermined for the vehicle V in step S150. Based on the comparison results, the CPU 11 determines

(1) Whether the relative distance Lr between the vehicle V and the target preceding vehicle is less than the value Lj_th of the approach distance threshold

(2) Whether the speed Vo of the vehicle V is less than the target speed Vtgc predetermined for the vehicle V in step S150.

An affirmative determination that the relative distance Lr is less than the value Lj_th of the approach distance threshold and that the speed Vo of the vehicle V is less than the target speed Vtgc predetermined for the vehicle V (YES in step S150) shows one of the following first and second situations:

(1) The first situation is that the vehicle V, which is running at the speed Vo lower than the target speed Vtgc, has caught up with the target preceding vehicle

(2) The second situation is that the vehicle V, which is running at the speed Vo lower than the target speed Vtgc, is about to be catching up with the target preceding vehicle.

Affirmative determination results in the lane-change assistance routine proceeding to the following step S160. Otherwise, neither the relative distance Lr being less than the value Lj_th of the approach distance threshold nor the speed Vo of the vehicle V being less than the target speed Vtgc predetermined for the vehicle V (NO in step S150) results in the lane-change assistance routine proceeding to step S270 described later.

In step S160, the CPU 11 determines whether an overtaking lane, i.e. a passing lane, exists adjacent to the lane on which the vehicle V is currently running according to the various pieces of information obtained in step S110. In particular, the CPU 11 performs the determination in step S160 using the information indicative of the number of lanes in front of the road on which the vehicle V and/or the information indicative of the locations of non-overtaking zones in front of the current location of the vehicle V.

In step S160, the CPU 11 can determine whether types of lane markers provided on the road on which the vehicle V is currently running show NO OVERTAKING OR PASSING using the three-dimensional images around the vehicle V obtained by the inter-vehicle distance measuring unit 23.

When it is determined that overtaking lanes, through which the vehicle V can make a lane change, are not provided on the current running road of the vehicle V (NO in step S160), the lane-change assistance routine proceeds to step S270 described later. Additionally, when it is determined that the types of the lane markers provided on the current running road of the vehicle V show NO OVERTAKING OR PASSING (NO in step S160), the lane-change assistance routine proceeds to step S270 described later.

Otherwise, when it is determined that an overtaking lane, through which the vehicle V can make a lane change, is provided in adjacent to the current running lane (YES in step S160), the lane-change assistance routine proceeds to the following step S170. Additionally, when it is determined that the types of the lane markers provided on the current running road of the vehicle V do not show NO OVERTAKING OR PASSING (YES in step S160), the lane-change assistance routine proceeds to the following S170.

In step S170, the CPU 11 determines whether the lane-change risk is a low level which is sufficiently acceptable according to, for example, the collision probability of the target preceding vehicle obtained in step S130. Specifically, when it is determined that the collision probability of the target preceding vehicle obtained in step S130 is equal to or higher than a predetermined threshold, the CPU 11 determines that lane-change risk is a high level which is unacceptable (NO in step S170), so that the lane-change assistance routine proceeds to step S270.

Otherwise, when it is determined that the collision probability of the target preceding vehicle obtained in step S130 is lower than the predetermined threshold, the CPU 11 determines that lane-change risk is a low level which is sufficiently acceptable (YES in step S170), so that the lane-change assistance routine proceeds to step S210.

In step S210, the CPU 11 predicts an overtaking course, i.e. a passing course, from the current location of the vehicle V to a future location of the vehicle V on the current running lane via the overtaking lane when assuming that the vehicle V safely and reliably passes the at least one preceding vehicle. Then, the CPU 11 calculates a minimum running distance Lo included in the predicted overtaking course and required for the vehicle V to run from the current location up to the predicted future location of the vehicle V. That is, the minimum running distance Lo is defined between the current location of the vehicle V and the predicted future location of the vehicle V. The minimum running distance Lo will be referred to as an overtaking requirement distance, i.e. a passing requirement distance, Lo.

Specifically, if the target preceding vehicle is a single preceding vehicle, the CPU 11 calculates the overtaking requirement distance Lo based on the speed Vf of the target preceding vehicle, a target passing speed Vtgo set to be higher than the speed Vf of the target preceding vehicle, and the relative distance Lr of the target preceding vehicle with respect to the vehicle V.

Otherwise, if a plurality of preceding vehicles are running as a group ahead of the vehicle V, the CPU 11 calculates the overtaking requirement distance Lo required for the vehicle V to safely and reliably pass the group of the preceding vehicles in step S210. In other words, the predicted future location of the vehicle V is positioned in front of the leading preceding vehicle in the group of the preceding vehicles.

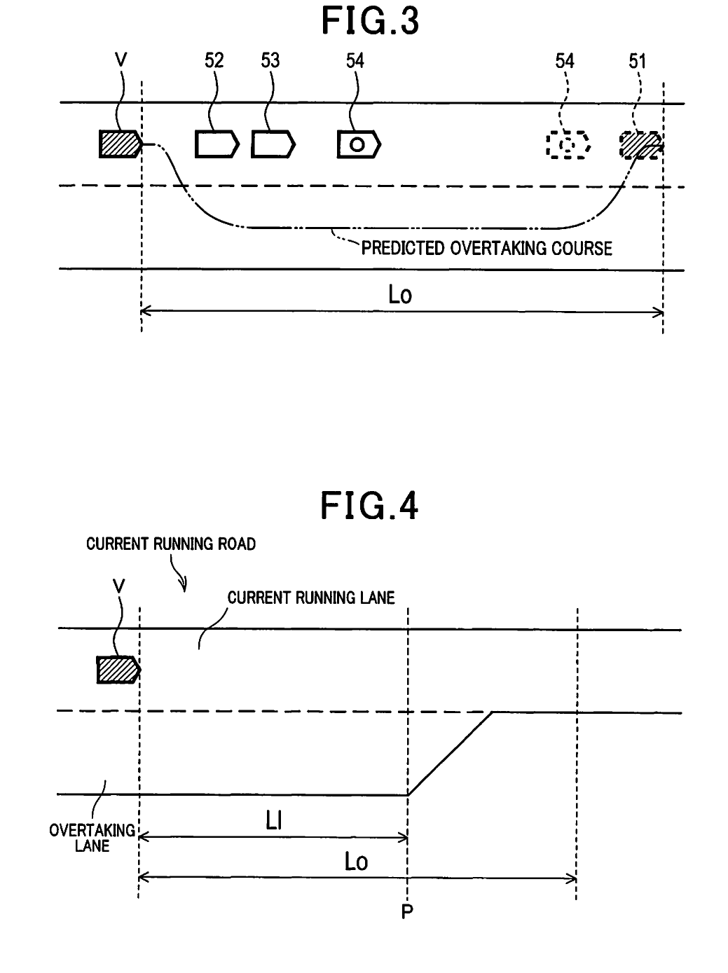

For example, referring to FIG. 3, assuming that there are three preceding vehicles 52, 53, and 54 ahead of the vehicle V, the CPU 11 calculates the overtaking requirement distance Lo required for the CPU 11 to safely pass the group of the preceding vehicles 52 to 54 in step S210. Specifically, the CPU 11 calculates the speed Vf of the leading preceding vehicle 54 in the group of the preceding vehicles 52 to 54 based on information obtained by the inter-vehicle distance measuring unit 23 and the other-vehicle information obtaining unit 22. In addition, the CPU 11 calculates the relative distance Lr between the current location of the leading preceding vehicle and the vehicle V, and divides the calculated relative distance Lr by the relative speed Vr of the leading preceding vehicle with respect to the vehicle V in the same manner as step S130.

Then, the CPU 11 calculates the overtaking requirement distance Lo based on the speed Vf of the leading preceding vehicle 54, the target passing speed Vtgo set to be higher than the speed Vf of the leading preceding vehicle, and the relative distance Lr of the leading preceding vehicle with respect to the vehicle V.

Next, in step S215, the CPU 11 determines whether there are one or more physical impediments for the overtaking of the one or more preceding vehicles through the predicted overtaking course based on the various pieces of information obtained in step S110. For example, physical impediments for overtaking in front of the current location of the vehicle V include that

(1) The number of lanes in the current running road in front of the current location of the vehicle V decreases due to, for example, the location of a construction site

(2) Another vehicle running on the overtaking lane at a speed lower than the speed Vf of the single preceding vehicle or the leading preceding vehicle

(3) A blocked portion of the current running road in front of the vehicle V due to an accident or a construction work

(4) There is a non-overtaking zone in front of the current location of the vehicle V due to traffic regulations including traffic laws

(5) The number of lanes in the current running road in front of the vehicle V decreases so that the overtaking lane will end (see FIG. 4)

(6) A traffic jam is occurring in front of the current location of the vehicle V.

(7) There is a junction or an intersection in front of the current location of the vehicle V

When determining that there are no physical impediments for the overtaking of the one or more preceding vehicles through the predicted overtaking course (NO in step S215), the lane-change assistance routine proceeds to step S270.

Otherwise, when determining that there are one or more physical impediments for the overtaking of the one or more preceding vehicles through the predicted overtaking course (YES in step S215), the CPU 11 calculates a minimum distance LI between the current location of the vehicle V and the location of a closest physical impediment for the overtaking of the one or more preceding vehicles through the predicted overtaking course in step S220.

That is, the minimum distance LI is a minimum distance between the current location of the vehicle V and the location of a single physical impediment if it is determined that there is such a single physical impediment in step S215. The minimum distance LI is also a minimum distance between the current location of the vehicle V and the location of a closest one of physical impediments if it is determined that there are such physical impediments in step S215.

In a case of a physical impediment for overtaking illustrated in FIG. 4, the minimum distance LI between the current location of the vehicle V and the location of a physical impediment for overtaking represents a minimum distance from the front of the vehicle V at the current location to a position P of the overtaking lane at which the start of the overtaking lane to be narrowed.

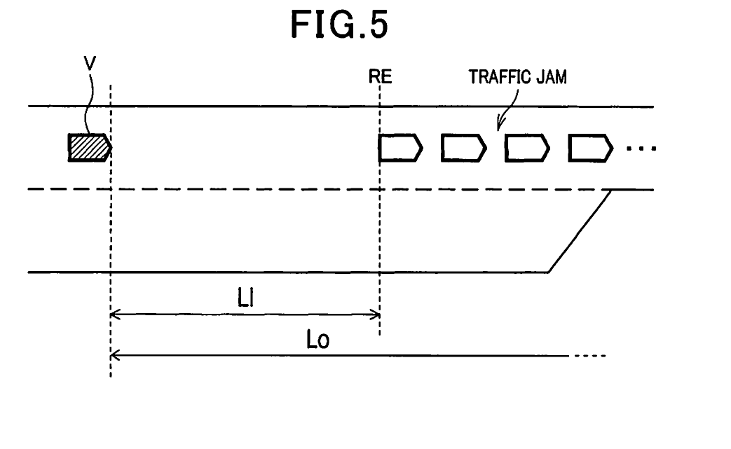

In another case of a physical impediment for overtaking illustrated in FIG. 5, the minimum distance LI between the current location of the vehicle V and the location of the physical impediment for overtaking represents a minimum distance from the front of the vehicle V at the current location to the rear end RE of the vehicle at the tail end of the traffic jam.

Following the operation in step S220, the CPU 11 compares the overtaking requirement distance Lo with the minimum distance LI in step S230. Based on the comparison results, the CPU 11 determines whether the minimum distance LI is longer than the overtaking requirement distance Lo in step S230.

When determining that the minimum distance LI is longer than the overtaking requirement distance Lo (YES in step S230), the CPU 11 determines that the vehicle V is enabled to pass the one or more preceding vehicles. Otherwise, when determining that the minimum distance LI is equal to or shorter than the overtaking requirement distance Lo (NO in step S230), the CPU 11 determines that the vehicle V is disabled from passing the one or more preceding vehicles.

An affirmative determination in step S230 results in execution of the lane-change assistance routine proceeding to step S240. Otherwise, a negative determination in step S230 results in execution of the lane-change assistance routine proceeding to step S270.

In step S240, the CPU 11 creates, as the first suggestion, i.e. the first navigation, audible and visible information that recommends the driver driving the vehicle V to pass the one or more preceding vehicles.

In contrast, in step S270, the CPU 11 determines whether the driver of the vehicle V has an intention to make a lane change according to, for example, the operating conditions of the right and left directional indicators 15 and 16, and/or the operated condition of the passing switch.

When determining that the driver of the vehicle V has no intention to make a lane change (NO in step S270), the CPU 11 terminates the lane-change assistance routine without any suggestions to the driver of the vehicle V.

Otherwise, when determining that the driver of the vehicle V has an intention to make a lane change (YES in step S270), the CPU 11 creates, as the second suggestion, i.e. the second navigation, audible and visible information that recommends the driver stopping a lane change in step S280.

Following the operation in step S240 or S280, the CPU 11 instructs the informing unit 27 to give, to the driver of the vehicle V, the first suggestion or the second suggestion using the speaker and the display in step S290.

Specifically, when it is determined that the minimum distance LI is longer than the overtaking requirement distance Lo (YES in step S230), the CPU 11 instructs the informing unit 27 to give, to the driver of the vehicle V, the first suggestion (the first navigation) using the speaker and the display in step S290. This suggests that the driver driving the vehicle V should pass the one or more preceding vehicles.

Otherwise, as illustrated in FIG. 4 or FIG. 5, when it is determined that the minimum distance LI is equal or shorter than the overtaking requirement distance Lo (NO in step S230), the CPU 11 instructs the informing unit 27 to give, to the driver of the vehicle V, the second suggestion (the second navigation) using the speaker and the display in step S290. This suggests that the driver should stop a lane change.

After completion of the operation in step S290, the CPU 11 terminates the lane-change assistance routine.

As described above, the driver assist system 1 includes a first obtaining unit, which is comprised of, for example, the other-vehicle information obtaining unit 22 and the operation in step S110. The first obtaining unit obtains first information including at least a current location and the behavior of at least one preceding vehicle running ahead of the vehicle V. The driver assist system 1 also includes a second obtaining unit, which is comprised of, for example, the sensors 20, the navigation apparatus 21, and the operation in step S110. The second obtaining unit obtains second information indicative of a current location and the behavior of the vehicle V.

The driver assist system 1 includes a predicting unit, which is comprised of, for example, the inter-vehicle distance obtaining unit 23, the and operations in steps S110 and S210). The predicting unit predicts an overtaking course from the current location of the vehicle V to a future location of the vehicle V when assuming that the vehicle V safely overtakes the at least one running preceding vehicle.

The driver assist system 1 includes a determining unit, which is comprised of, for example, the navigation apparatus 21, and the operations in steps S110 and S215. The determining unit determines whether there are one or more physical impediments for the overtaking of the one or more preceding vehicles through the predicted overtaking course based on the various pieces of information obtained in step S110.

The driver assist system 1 includes an adjusting unit, which is comprised of, for example, the operations in steps S220, S230, S240, S270, S280, and S290. According to the results of the determination of whether there are one or more physical impediments for the overtaking of the one or more preceding vehicles through the predicted overtaking course, the adjusting unit adjusts assistance for the driver of the vehicle V for the overtaking of the one or more preceding vehicles.

This configuration therefore suitably assists the driver when the driver tries to overtake the one or more preceding vehicles according to whether there are one or more physical impediments for the overtaking, i.e. whether the driver enables the vehicle V to safely pass the one or more preceding vehicles.

The one or more physical impediments for the overtaking of the one or more preceding vehicles through the predicted overtaking course include, for example, that

(1) The number of lanes in the current running road in front of the current location of the vehicle V decreases due to, for example, the location of a construction site

(2) Another vehicle running on the overtaking lane at a speed lower than the speed Vf of the single preceding vehicle or the leading preceding vehicle

(3) A blocked portion of the current running road in front of the vehicle V due to an accident or a construction work

(4) There is a non-passing zone, i.e. a non-overtaking zone, in front of the location of the vehicle V due to traffic regulations

(5) The number of lanes in the current running road in front of the vehicle V decreases so that the overtaking lane is reduced (see FIG. 4)

(6) A traffic jam is occurring in front of the current location of the vehicle V.

(7) There is a junction or an intersection in front of the current location of the vehicle V.

That is, if there is at least one of these physical impediments in the predicted overtaking course, the at least one of these physical impediments may certainly constitute an obstacle to the overtaking of the one or more preceding vehicles through the predicted overtaking course by the vehicle V. The driver assist system 1 therefore further stably and reliably assists the driver not to try to overtake the one or more preceding vehicles when it is determined that there is at least one physical impediment for the overtaking.

The controller 10, which serves as, for example, the adjusting unit, is configured to carry out assistance for the driver of the vehicle V for the overtaking of the one or more preceding vehicles when it is determined that there are no physical impediments for the overtaking (see steps S215, S220, S230, S240, and S290).

In other words, the controller 10 is configured not to carry out assistance for the driver of the vehicle V for the overtaking of the one or more preceding vehicles when it is determined that there is at least one physical impediment for the overtaking (see steps S215 and S270). This configuration enables the driver to safely pass the one or more preceding vehicles without any obstacle due to such physical impediments, and disables the driver from passing the one or more preceding vehicles, thus preventing any trouble due to such physical impediments.

In particular, the controller 10, which serves as, for example, an intention determining unit, is configured to determine whether the driver of the vehicle V has an intention to make a lane change when it is determined that there are one or more physical impediments for the overtaking of the one or more preceding vehicles through the predicted overtaking course (see step S270). The controller 10 is configured not to carry out assistance for the driver of the vehicle V for the overtaking of the one or more preceding vehicles when it is determined that the drive has no intention to make a lane change (see NO in step S280). In contrast, the controller 10 is configured to carry out assistance for the driver of the vehicle V not to overtake the one or more preceding vehicles when it is determined that the drive has an intention to make a lane change (see YES in step S280 and S290).

This configuration reliably enables the driver to stop overtaking of the one or more preceding vehicles even if the driver has an intention to make a lane change when there are one or more physical impediments for the overtaking of the one or more preceding vehicles.

The controller 10, which serves as, for example, the predicting unit, calculates the overtaking requirement distance Lo included in the predicted overtaking course and required for the vehicle V to run from the current location up to the predicted future location of the vehicle V. Additionally, if it is determined that there are one or more impediments (see YES in step S215), the controller 10, which serves as, for example, a minimum distance calculating unit. The minimum distance calculating unit calculates a minimum distance LI between the current location of the vehicle V and the location(s) of the one or more physical impediments for the overtaking of the one or more preceding vehicles through the predicted passing course. Then, the controller 10 serves as, for example, a distance determining unit that determines whether the minimum distance LI is longer than the overtaking requirement distance Lo (see step S230). When it is determined that the minimum distance LI is longer than the overtaking requirement distance Lo, the controller 10 serves as, for example, the adjusting unit. The adjusting unit carries out assistance for the driver to overtake the one or more preceding vehicles although there are one or more physical impediments for the overtaking through the predicted passing course (see YES in step S230, S240, and S290). This configuration enables the driver to pass the one or more preceding vehicles when it is determined that there are one or more physical impediments for the overtaking of the one or more preceding vehicles, and the one or more physical impediments do not have an adverse effect on the overtaking of the one or more preceding vehicles.

The controller 10, which serves as, for example, the predicting unit, calculates the overtaking requirement distance Lo from the current location of the vehicle V up to the predicted future location of the vehicle V such that the predicted future location being positioned in front of the leading preceding vehicle in the group of the preceding vehicles. In other others, the overtaking requirement distance Lo is required for the vehicle V to safely pass the group of the preceding vehicles if the preceding vehicles are running in front of the vehicle V as the group. This configuration carries out suitable assistance for the driver of the vehicle V when the driver V tries to pass the group of the preceding vehicles.

The present disclosure is not limited to this embodiment set forth above. Various modifications identified by the words described in the following claims can be included in other embodiments of the present disclosure as long as they can be within the scope of the present disclosure.

The driver assist system 1 according to this embodiment is configured to instruct the informing unit 27 to give, to the driver of the vehicle V, the first suggestion or the second suggestion using the speaker and the display in step S290 during execution of the adaptive cruise control (ACC) routine. The present disclosure is however not limited to the configuration.

Specifically, the driver assist system 1 can serve to control the actuators of the vehicle-behavior controller 26 to automatically adjust the speed and steering of the vehicle V. The driver assist system 1 according to this modification controls the actuators of the vehicle-behavior controller 26 to automatically start a lane change from the current running lane to the passing lane based on the predicted overtaking course when carrying out the first suggestion. Additionally, the driver assist system 1 according to this modification controls the actuators of the vehicle-behavior controller 26 to automatically interrupt the lane change to return to the original running lane when carrying out the second suggestion.

The driver assist system 1 according to this embodiment serves as a system for performing the adaptive cruise control routine, but can serve as a navigation system. Specifically, the driver assist system 1 according to this modification serves to give, to the driver of the vehicle V, the first suggestion (the first navigation) using the speaker and the display in step S290 when it is determined that the minimum distance LI is longer than the overtaking requirement distance Lo (YES in step S230). This guides the driver to drive the vehicle V so as to pass the one or more preceding vehicles. The driver assist system 1 according to this modification also serves to give, to the driver of the vehicle V, the second suggestion (the second navigation) using the speaker and the display in step S290 when it is determined that the minimum distance LI is equal or shorter than the overtaking requirement distance Lo (NO in step S230). This guides the driver to stop a lane change.

While the illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An apparatus for assisting a driver of a target vehicle running on a road, the apparatus comprising:
a first obtaining unit that obtains first information including at least a current location and a behavior of at least one preceding vehicle running on the road ahead of the target vehicle;
a second obtaining unit that obtains second information indicative of a current location and a behavior of the target vehicle;
a predicting unit that predicts, based on the first information and the second information, an overtaking course from the current location of the target vehicle to a future location of the target vehicle when assuming that the target vehicle will safely overtake at least one preceding vehicle;
a determining unit that:
obtains traffic information associated with at least a portion in the road, the portion being located in front of the current location of the target vehicle; and
determine whether there are one or more physical impediments for an overtaking of the at least one preceding vehicle through the predicted overtaking course based on at least the traffic information; and
an adjusting unit that adjusts assistance for the driver of the target vehicle for the overtaking of the at least one preceding vehicle according to a result of the determination of whether there is at least one physical impediment for the overtaking of the at least one preceding vehicle through the predicted overtaking course.

2. The apparatus according to claim 1, wherein the target vehicle and the at least one preceding vehicle are currently running on a lane of the road, the road includes an overtaking lane provided adjacent to the lane, and the one or more physical impediments for an overtaking of the at least one preceding vehicle through the predicted overtaking course include:
a first physical impediment that a number of lanes in the road in front of the current location of the target vehicle decreases;
a second physical impediment that another vehicle running on the overtaking lane at a speed lower than a speed of the at least one preceding vehicle
a third physical impediment that a blocked portion of the road in front of the target vehicle due to an accident or a construction work
a fourth physical impediment that there is a non-overtaking zone in front of the current location of the target vehicle due to traffic regulations or laws
a fifth physical impediment that a traffic jam is occurring in front of the current location of the target vehicle; and
a sixth physical impediment that there is a junction or an intersection in front of the current location of the target vehicle.

3. The apparatus according to claim 1, wherein the adjusting unit is configured to:
carry out assistance for the driver of the target vehicle for the overtaking of the at least one preceding vehicle when it is determined that there are no physical impediments for the overtaking of the at least one preceding vehicle through the predicted overtaking course; and
not carry out assistance for the driver of the target vehicle for the overtaking of the at least one preceding vehicle when it is determined that there are one or more physical impediments for the overtaking of the at least one preceding vehicle through the predicted overtaking course.

4. The apparatus according to claim 1, further comprising:
an intention determining unit that determines whether the driver of the target vehicle has an intention to make a lane change when it is determined that there are one or more physical impediments for the overtaking of the at least one preceding vehicle through the predicted overtaking course,
wherein the adjusting unit is configured to:
not carry out assistance for the driver of the target vehicle for the overtaking of the at least one preceding vehicle when it is determined that the driver has no intention to make a lane change; and
carry out assistance to alert the driver of the target vehicle not to overtake the at least one preceding vehicle when it is determined that the driver has an intention to make a lane change.

5. The apparatus according to claim 1, wherein the predicting unit is configured to calculate an overtaking requirement distance included in the predicted overtaking course, the overtaking requirement distance being required for the target vehicle to run from the current location up to the predicted future location of the target vehicle, the apparatus further comprising:
a minimum distance calculating unit that calculates a minimum distance between the current location of the target vehicle and a location of the one or more physical impediments for the overtaking of the at least one preceding vehicle through the predicted passing course when it is determined that there are one or more physical impediments for the overtaking of the at least one preceding vehicle through the predicted overtaking course; and
a distance determining unit that determines whether the minimum distance is longer than the overtaking requirement distance,
although when it is determined that there are one or more physical impediments, the adjusting unit being configured to carry out assistance for the driver to overtake the at least one preceding vehicle when it is determined that the minimum distance is longer than the overtaking requirement distance.

6. The apparatus according to claim 5, wherein:
the at least one preceding vehicle comprises a plurality of preceding vehicles running ahead of the target vehicle, and
the predicting unit is configured to calculate the overtaking requirement distance included in the predicted overtaking course, the overtaking requirement distance being required for the target vehicle to safely overtake a group of the plurality of preceding vehicles.

7. A computer program product for an apparatus for assisting a driver of a target vehicle running on a road, the computer program product comprising:
a non-transitory computer-readable storage medium; and
a set of computer program instructions embedded in the computer-readable storage medium, the instructions causing a computer to carry out:
a first step of obtaining first information including at least a current location and a behavior of at least one preceding vehicle running on the road ahead of the target vehicle;
a second step of obtaining second information indicative of a current location and a behavior of the target vehicle;
a third step of predicting, based on the first information and the second information, an overtaking course from the current location of the target vehicle to a future location of the target vehicle when assuming that the target vehicle safely overtakes the at least one preceding vehicle;
a fourth step of obtaining traffic information associated with at least a portion in the road, the portion being located in front of the current location of the target vehicle;
a fifth step of determining whether there are one or more physical impediments for an overtaking of the at least one preceding vehicle through the predicted overtaking course based on at least the traffic information; and
a sixth step of adjusting assistance for the driver of the target vehicle for the overtaking of the at least one preceding vehicle according to a result of the determination of whether there is at least one physical impediment for the overtaking of the at least one preceding vehicle through the predicted overtaking course.

8. The computer program product according to claim 7, wherein the target vehicle and the at least one preceding vehicle are currently running on a lane of the road, the road includes an overtaking lane provided adjacent to the lane, and the one or more physical impediments for an overtaking of the at least one preceding vehicle through the predicted overtaking course include:
a first physical impediment that a number of lanes in the road in front of the current location of the target vehicle decreases;
a second physical impediment that another vehicle running on the overtaking lane at a speed lower than a speed of the at least one preceding vehicle
a third physical impediment that a blocked portion of the road in front of the target vehicle due to an accident or a construction work
a fourth physical impediment that there is a non-overtaking zone in front of the current location of the target vehicle due to traffic regulations or laws
a fifth physical impediment that a traffic jam is occurring in front of the current location of the target vehicle; and
a sixth physical impediment that there is a junction or an intersection in front of the current location of the target vehicle.

9. The computer program product according to claim 7, wherein the sixth step is configured to:
carry out assistance for the driver of the target vehicle for the overtaking of the at least one preceding vehicle when it is determined that there are no physical impediments for the overtaking of the at least one preceding vehicle through the predicted overtaking course; and
not carry out assistance for the driver of the target vehicle for the overtaking of the at least one preceding vehicle when it is determined that there are one or more physical impediments for the overtaking of the at least one preceding vehicle through the predicted overtaking course.

10. The computer program product according to claim 7, wherein the instructions causing a computer to further carry out:
a seventh step of determines whether the driver of the target vehicle has an intention to make a lane change when it is determined that there are one or more physical impediments for the overtaking of the at least one preceding vehicle through the predicted overtaking course,
wherein the sixth step is configured to:
not carry out assistance for the driver of the target vehicle for the overtaking of the at least one preceding vehicle when it is determined that the driver has no intention to make a lane change; and
carry out assistance to alert the driver of the target vehicle not to overtake the at least one preceding vehicle when it is determined that the driver has an intention to make a lane change.

11. The computer program according to claim 7, wherein the third step is configured to calculate an overtaking requirement distance included in the predicted overtaking course, the overtaking requirement distance being required for the target vehicle to run from the current location up to the predicted future location of the target vehicle, the instructions causing a computer to further carry out:
a seventh step of calculating a minimum distance between the current location of the target vehicle and a location of the one or more physical impediments for the overtaking of the at least one preceding vehicle through the predicted passing course when it is determined that there are the one or more physical impediments for the overtaking of the at least one preceding vehicle through the predicted overtaking course; and
an eight step of determining unit that determines whether the minimum distance is longer than the overtaking requirement distance,
although when it is determined that there are one or more physical impediments for the overtaking through the predicted passing course, the sixth step being configured to carry out assistance for the driver to overtake the at least one preceding vehicle when it is determined that the minimum distance is longer than the overtaking requirement distance.

12. The computer program according to claim 11, wherein the at least one preceding vehicle comprises a plurality of preceding vehicles running ahead of the target vehicle, and
the third step is configured to calculate the overtaking requirement distance included in the predicted overtaking course, the overtaking requirement distance being required for the target vehicle to safely overtake a group of the plurality of preceding vehicles.
